(19) United States
(12) Patent Application Publication
(10) Pub. No.: US 2025/0029117 A1
(43) Pub. Date: Jan. 23, 2025

(54) Apparatus, method and computer program

(71) Applicant: Nokia Technologies Oy, Espoo (FI)

(72) Inventors: Huanzhuo WU, Munich (DE); Bahare MASOOD KHORSANDI, Munich (DE); Abdelrahman ABDELKADER, Munich (DE); Hajer BRAHAM, Massy (FR); Borislava GAJIC, Munich (DE)

(21) Appl. No.: 18/750,062

(22) Filed: Jun. 21, 2024

(30) Foreign Application Priority Data
Jul. 17, 2023 (GB) 2310905.1

(51) Int. Cl. G06Q 30/018; G06N 5/04

(52) U.S. Cl. CPC G06Q 30/018; G06N 5/04

(57) ABSTRACT

There is provided an apparatus comprising means for: receiving a request to offload at least one inference step of a ML model for an application to a host node of a network comprising a plurality of host nodes, acquiring first information related to the application, acquiring second information related to the ML model, acquiring third information related to at least one host node, wherein the third information comprises at least an indication of a carbon emission footprint associated with at least one host node, determining, based on the first information, the second information and the third information, at least one deployment option of at least one inference step to offload on at least one host node and providing an indication of the determined at least one deployment option to the second entity from the first entity.

### FIELD

The present application relates to a method, apparatus, system and computer program and in particular but not exclusively to environmental-aware federated inference orchestration.

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communication sessions may comprise, for example, communication of data for carrying communications such as voice, video, electronic mail (email), text message, multimedia and/or content data and so on. Non-limiting examples of services provided comprise two-way or multi-way calls, data communication or multimedia services and access to a data network system, such as the Internet.

In a wireless communication system at least a part of a communication session between at least two stations occurs over a wireless link. Examples of wireless systems comprise public land mobile networks (PLMN), satellite based communication systems and different wireless local networks, for example wireless local area networks (WLAN). Some wireless systems can be divided into cells, and are therefore often referred to as cellular systems.

A user can access the communication system by means of an appropriate communication device or terminal. A communication device of a user may be referred to as user equipment (UE) or user device. A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. One example of a communications system is Universal Mobile Telecommunications System (UMTS) Terrestrial Radio Access Network (UTRAN) (3G radio). Other examples of communication systems are the long-term evolution (LTE) of the Universal Mobile Telecommunications System (UMTS) radio-access technology and so-called 5G or New Radio (NR) networks. NR is being standardized by the 3rd Generation Partnership Project (3GPP). Other examples of communication systems include 5G-Advanced (NR Rel-18 and beyond) and 6G.

### SUMMARY

In a first aspect there is provided an apparatus comprising means for receiving, at a first entity from a second entity, a request to offload at least one inference step of a machine learning model for an application to a host node of a network, the network comprising a plurality of host nodes, means for acquiring first information related to the application, means for acquiring second information related to the machine learning model, means for acquiring third information related to at least one host node of the plurality of host nodes, wherein the third information comprises at least an indication of a carbon emission footprint associated with at least one host node of the plurality of host nodes, means for determining, based on the first information, the second information and the third information, at least one deployment option of at least one inference step to offload on at least one host node of the plurality of host nodes; and means for providing an indication of the determined at least one deployment option to the second entity from the first entity.

Means for acquiring the first information may comprise means for receiving the first information at the first entity from the second entity.

Means for acquiring the second information may comprise means for requesting the second information from a network function and means for receiving the second information from the network function.

Means for acquiring the third information may comprise means for requesting the third information from a further network function, and means for receiving the third information from the further network function.

The first information may comprise an indication of at least one inference step of the machine learning model to be offloaded to at least one of the plurality of host nodes.

The first information may comprise a quality of service indicator.

The first information may comprise at least one of time sensitivity information, hardware requirements of at least one inference step and data privacy requirements of at least one inference step

The request may comprise the first information.

The third information may further comprise an indication of computing capacity of at least one host node of the plurality of host nodes.

The second information may comprise at least one of input data size, output data size, computing complexity and parameter size of at least one inference step of the machine learning model.

The first entity may comprise a management service producer hosted on a network function.

The second entity may comprise at least one of a user equipment, a management services consumer hosted on a network function or a machine learning entity.

The plurality of host nodes may comprise at least one of edge cloud servers, centre cloud servers and network function servers.

In a second aspect there is provided an apparatus comprising means for providing, to a first entity from a second entity, a request to offload at least one inference step of a machine learning model for an application to a network, the network comprising a plurality of host nodes and means for receiving, from the first entity at the second entity an indication of a determined at least one deployment option of at least one inference step to offload on at least one host node of the plurality of host nodes, the at least one deployment option determined by the first entity based on first information related to the application, second information related to the machine learning model and third information related to at least one host node of the plurality of host nodes, wherein the third information comprises at least an indication of a carbon emission footprint associated with at least one host node of the plurality of host nodes.

The apparatus may comprise means for providing the first information to the first entity from the second entity.

The first information may comprise an indication of at least one inference step of the machine learning model to be offloaded to at least one of the plurality of host nodes.

The first information may comprise a quality of service indicator.

The first information may comprise at least one of time sensitivity information, hardware requirements of at least one inference step and data privacy requirements of at least one inference step

The request may comprise the first information.

The third information may further comprise an indication of computing capacity of at least one host node of the plurality of host nodes.

The second information may comprise at least one of input data size, output data size, computing complexity and parameter size of at least one inference step of the machine learning model.

The first entity may comprise a management service producer hosted on a network function.

The second entity may comprise at least one of a user equipment, a management services consumer hosted on a network function or a machine learning entity.

The plurality of host nodes may comprise at least one of edge cloud servers, centre cloud servers and network function servers.

The apparatus may comprise means for receiving an indication of a plurality of deployment options from the first entity and determining to use one of the deployment options to offload at least one inference step to at least one host node.

In a third aspect there is provided a method comprising receiving, at a first entity from a second entity, a request to offload at least one inference step of a machine learning model for an application to a host node of a network, the network comprising a plurality of host nodes, acquiring first information related to the application, means for acquiring second information related to the machine learning model, acquiring third information related to at least one host node of the plurality of host nodes, wherein the third information comprises at least an indication of a carbon emission footprint associated with at least one host node of the plurality of host nodes, determining, based on the first information, the second information and the third information, at least one deployment option of at least one inference step to offload on at least one host node of the plurality of host nodes and providing an indication of the determined at least one deployment option to the second entity from the first entity.

Acquiring the first information may comprise receiving the first information at the first entity from the second entity.

Acquiring the second information may comprise requesting the second information from a network function and receiving the second information from the network function.

Acquiring the third information may comprise requesting the third information from a further network function, and receiving the third information from the further network function.

The first information may comprise an indication of at least one inference step of the machine learning model to be offloaded to at least one of the plurality of host nodes.

The first information may comprise a quality of service indicator.

The first information may comprise at least one of time sensitivity information, hardware requirements of at least one inference step and data privacy requirements of at least one inference step

The request may comprise the first information.

The third information may further comprise an indication of computing capacity of at least one host node of the plurality of host nodes.

The second information may comprise at least one of input data size, output data size, computing complexity and parameter size of at least one inference step of the machine learning model.

The first entity may comprise a management service producer hosted on a network function.

The second entity may comprise at least one of a user equipment, a management services consumer hosted on a network function or a machine learning entity.

The plurality of host nodes may comprise at least one of edge cloud servers, centre cloud servers and network function servers.

In a fourth aspect there is provided a method comprising providing, to a first entity from a second entity, a request to offload at least one inference step of a machine learning model for an application to a network, the network comprising a plurality of host nodes and receiving, from the first entity at the second entity an indication of a determined at least one deployment option of at least one inference step to offload on at least one host node of the plurality of host nodes, the at least one deployment option determined by the first entity based on first information related to the application, second information related to the machine learning model and third information related to at least one host node of the plurality of host nodes, wherein the third information comprises at least an indication of a carbon emission footprint associated with at least one host node of the plurality of host nodes.

The method may comprise providing the first information to the first entity from the second entity.

The first information may comprise an indication of at least one inference step of the machine learning model to be offloaded to at least one of the plurality of host nodes.

The first information may comprise a quality of service indicator.

The first information may comprise at least one of time sensitivity information, hardware requirements of at least one inference step and data privacy requirements of at least one inference step

The request may comprise the first information.

The third information may further comprise an indication of computing capacity of at least one host node of the plurality of host nodes.

The second information may comprise at least one of input data size, output data size, computing complexity and parameter size of at least one inference step of the machine learning model.

The first entity may comprise a management service producer hosted on a network function.

The second entity may comprise at least one of a user equipment, a management services consumer hosted on a network function or a machine learning entity.

The plurality of host nodes may comprise at least one of edge cloud servers, centre cloud servers and network function servers.

The method may comprise receiving an indication of a plurality of deployment options from the first entity and determining to use one of the deployment options to offload at least one inference step to at least one host node.

In a fifth aspect there is provided an apparatus comprising at least one processor, and at least one memory including computer program code, wherein the at least one memory and the computer program code are configured, with the at least one processor, to cause the apparatus at least to receive, at a first entity from a second entity, a request to offload at least one inference step of a machine learning model for an application to a host node of a network, the network comprising a plurality of host nodes, acquire first information related to the application, acquire second information related to the machine learning model, acquire third information related to at least one host node of the plurality of host nodes, wherein the third information comprises at least an indication of a carbon emission footprint associated with at least one host node of the plurality of host nodes, determine, based on the first information, the second information and the third information, at least one deployment option of at least one inference step to offload on at least one host node of the plurality of host nodes and provide an indication of the determined at least one deployment option to the second entity from the first entity.

The apparatus may be caused to receive the first information at the first entity from the second entity.

The apparatus may be caused to request the second information from a network function and receive the second information from the network function.

The apparatus may be caused to request the third information from a further network function, and receive the third information from the further network function.

The first information may comprise an indication of at least one inference step of the machine learning model to be offloaded to at least one of the plurality of host nodes.

The first information may comprise a quality of service indicator.

The first information may comprise at least one of time sensitivity information, hardware requirements of at least one inference step and data privacy requirements of at least one inference step

The request may comprise the first information.

The third information may further comprise an indication of computing capacity of at least one host node of the plurality of host nodes.

The second information may comprise at least one of input data size, output data size, computing complexity and parameter size of at least one inference step of the machine learning model.

The first entity may comprise a management service producer hosted on a network function.

The second entity may comprise at least one of a user equipment, a management services consumer hosted on a network function or a machine learning entity.

The plurality of host nodes may comprise at least one of edge cloud servers, centre cloud servers and network function servers.

In a sixth aspect there is provided an apparatus comprising at least one processor, and at least one memory including computer program code, wherein the at least one memory and the computer program code are configured, with the at least one processor, to cause the apparatus at least to provide, to a first entity from a second entity, a request to offload at least one inference step of a machine learning model for an application to a network, the network comprising a plurality of host nodes and receive, from the first entity at the second entity an indication of a determined at least one deployment option of at least one inference step to offload on at least one host node of the plurality of host nodes, the at least one deployment option determined by the first entity based on first information related to the application, second information related to the machine learning model and third information related to at least one host node of the plurality of host nodes, wherein the third information comprises at least an indication of a carbon emission footprint associated with at least one host node of the plurality of host nodes.

The apparatus may be caused to provide the first information to the first entity from the second entity.

The first information may comprise an indication of at least one inference step of the machine learning model to be offloaded to at least one of the plurality of host nodes.

The first information may comprise a quality of service indicator.

The first information may comprise at least one of time sensitivity information, hardware requirements of at least one inference step and data privacy requirements of at least one inference step

The request may comprise the first information.

The third information may further comprise an indication of computing capacity of at least one host node of the plurality of host nodes.

The second information may comprise at least one of input data size, output data size, computing complexity and parameter size of at least one inference step of the machine learning model.

The first entity may comprise a management service producer hosted on a network function.

The second entity may comprise at least one of a user equipment, a management services consumer hosted on a network function or a machine learning entity.

The plurality of host nodes may comprise at least one of edge cloud servers, centre cloud servers and network function servers.

The apparatus may be caused to receive an indication of a plurality of deployment options from the first entity and determining to use one of the deployment options to offload at least one inference step to at least one host node.

In a seventh aspect there is provided a computer readable medium comprising instructions which, when executed by an apparatus, cause the apparatus to perform at least the following receiving, at a first entity from a second entity, a request to offload at least one inference step of a machine learning model for an application to a host node of a network, the network comprising a plurality of host nodes, acquiring first information related to the application, acquiring second information related to the machine learning model, acquiring third information related to at least one host node of the plurality of host nodes, wherein the third information comprises at least an indication of a carbon emission footprint associated with at least one host node of the plurality of host nodes, determining, based on the first information, the second information and the third information, at least one deployment option of at least one inference step to offload on at least one host node of the plurality of host nodes and providing an indication of the determined at least one deployment option to the second entity from the first entity.

The apparatus may be caused to perform receiving the first information at the first entity from the second entity.

The apparatus may be caused to perform requesting the second information from a network function and receiving the second information from the network function.

The apparatus may be caused to perform requesting the third information from a further network function, and receiving the third information from the further network function.

The first information may comprise an indication of at least one inference step of the machine learning model to be offloaded to at least one of the plurality of host nodes.

The first information may comprise a quality of service indicator.

The first information may comprise at least one of time sensitivity information, hardware requirements of at least one inference step and data privacy requirements of at least one inference step

The request may comprise the first information.

The third information may further comprise an indication of computing capacity of at least one host node of the plurality of host nodes.

The second information may comprise at least one of input data size, output data size, computing complexity and parameter size of at least one inference step of the machine learning model.

The first entity may comprise a management service producer hosted on a network function.

The second entity may comprise at least one of a user equipment, a management services consumer hosted on a network function or a machine learning entity.

The plurality of host nodes may comprise at least one of edge cloud servers, centre cloud servers and network function servers.

In an eighth aspect there is provided a computer readable medium comprising instructions which, when executed by an apparatus, cause the apparatus to perform at least the following providing, to a first entity from a second entity, a request to offload at least one inference step of a machine learning model for an application to a network, the network comprising a plurality of host nodes and receiving, from the first entity at the second entity an indication of a determined at least one deployment option of at least one inference step to offload on at least one host node of the plurality of host nodes, the at least one deployment option determined by the first entity based on first information related to the application, second information related to the machine learning model and third information related to at least one host node of the plurality of host nodes, wherein the third information comprises at least an indication of a carbon emission footprint associated with at least one host node of the plurality of host nodes.

The apparatus may be caused to perform providing the first information to the first entity from the second entity.

The first information may comprise an indication of at least one inference step of the machine learning model to be offloaded to at least one of the plurality of host nodes.

The first information may comprise a quality of service indicator.

The first information may comprise at least one of time sensitivity information, hardware requirements of at least one inference step and data privacy requirements of at least one inference step.

The request may comprise the first information.

The third information may further comprise an indication of computing capacity of at least one host node of the plurality of host nodes.

The second information may comprise at least one of input data size, output data size, computing complexity and parameter size of at least one inference step of the machine learning model.

The first entity may comprise a management service producer hosted on a network function.

The second entity may comprise at least one of a user equipment, a management services consumer hosted on a network function or a machine learning entity.

The plurality of host nodes may comprise at least one of edge cloud servers, centre cloud servers and network function servers.

The apparatus may be caused to perform receiving an indication of a plurality of deployment options from the first entity and determining to use one of the deployment options to offload at least one inference step to at least one host node.

In a ninth aspect there is provided a non-transitory computer readable medium comprising program instructions for causing an apparatus to perform at least the method according to the third or fourth aspect.

In the above, many different embodiments have been described. It should be appreciated that further embodiments may be provided by the combination of any two or more of the embodiments described above.

### DESCRIPTION OF FIGURES

Embodiments will now be described, by way of example only, with reference to the accompanying Figures in which:

FIG. 1 shows a schematic diagram of an example 5GS communication system;

FIG. 2 shows a schematic diagram of an example mobile communication device;

FIG. 3 shows a schematic diagram of an example control apparatus;

FIG. 4 shows a schematic diagram of an AI/ML model split;

FIG. 5 shows a schematic diagram of an AI/ML model split;

FIG. 6 shows a schematic diagram of an AI/ML model split;

FIG. 7 shows a flowchart of a method according to an example embodiment;

FIG. 8 shows a flowchart of a method according to an example embodiment;

FIG. 9 shows a schematic diagram of federated deployment options according to an example;

FIG. 10 shows a signalling flow according to an example embodiment;

FIG. 11 shows a signalling flow according to an example embodiment.

### DETAILED DESCRIPTION

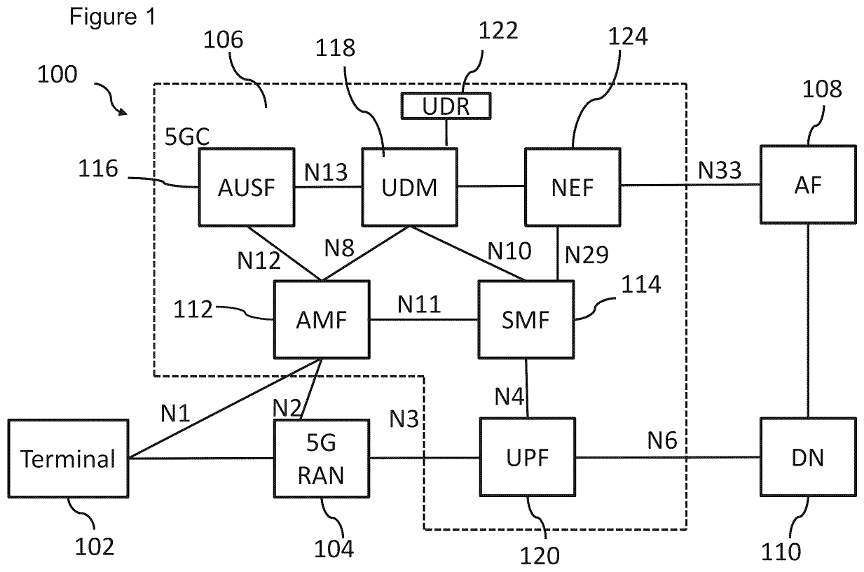

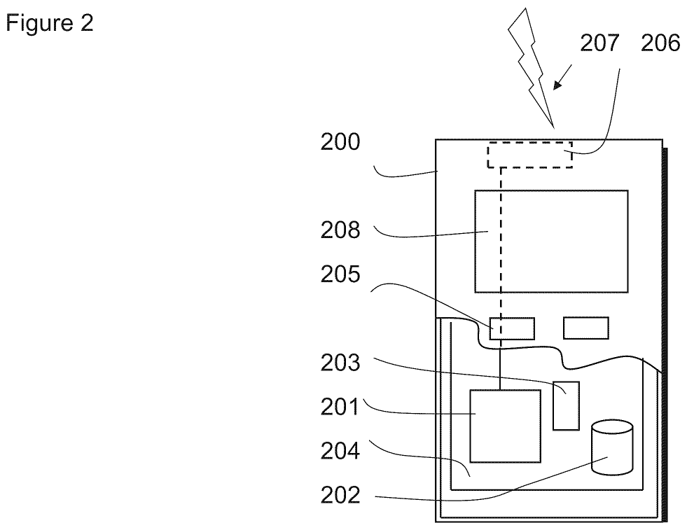

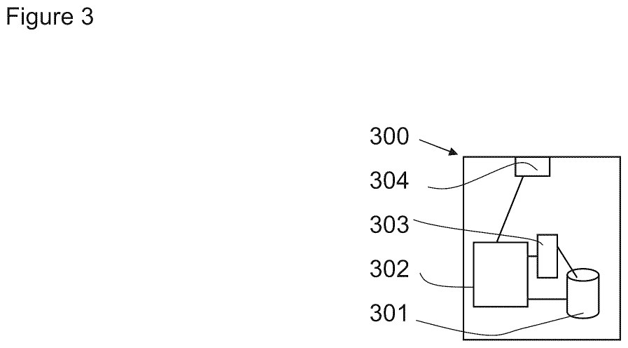

Before explaining in detail the examples, certain general principles of a wireless communication system and mobile communication devices are briefly explained with reference to FIG. 1, FIG. 2 and FIG. 3 to assist in understanding the technology underlying the described examples.

An example of a suitable communications system is the 5G or NR concept. Network architecture in NR may be similar to that of LTE-advanced. Base stations of NR systems may be known as next generation NodeBs (gNBs). Changes to the network architecture may depend on the need to support various radio technologies and finer Quality of Service (QOS) support, and some on-demand requirements for e.g. QoS levels to support Quality of Experience (QoE) for a user. Also network aware services and applications, and service and application aware networks may bring changes to the architecture. Those are related to Information Centric Network (ICN) and User-Centric Content Delivery Network (UC-CDN) approaches. NR may use Multiple Input—Multiple Output (MIMO) antennas, many more base stations or nodes than the LTE (a so-called small cell concept), including macro sites operating in co-operation with smaller stations and perhaps also employing a variety of radio technologies for better coverage and enhanced data rates.

Future networks may utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations to be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent.

FIG. 1 shows a schematic representation of a 5G system (5GS) 100. The 5GS may comprise a user equipment (UE) 102 (which may also be referred to as a communication device or a terminal), a 5G radio access network (5GRAN) 104, a 5G core network (5GCN) 106, one or more internal or external application functions (AF) 108 and one or more data networks (DN) 110.

An example 5G core network (CN) comprises functional entities. The 5GCN 106 may comprise one or more Access and mobility Management Functions (AMF) 112, one or more session management functions (SMF) 114, an authentication server function (AUSF) 116, a Unified

Data Management (UDM) 118, one or more user plane functions (UPF) 120, a Unified Data Repository (UDR) 122 and/or a Network Exposure Function (NEF) 124. The UPF is controlled by the SMF (Session Management Function) that receives policies from a PCF (Policy Control Function).

The CN is connected to a UE via the Radio Access Network (RAN). The 5GRAN may comprise one or more gNodeB (gNB) Distributed Unit (DU) functions connected to one or more gNodeB (gNB) Centralized Unit (CU) functions. The RAN may comprise one or more access nodes.

A User Plane Function (UPF) referred to as PDU Session Anchor (PSA) may be responsible for forwarding frames back and forth between the DN and the tunnels established over the 5G towards the UE(s) exchanging traffic with the DN.

A possible mobile communication device will now be described in more detail with reference to FIG. 2 showing a schematic, partially sectioned view of a communication device 200. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, voice over IP (VoIP) phones, portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), smart devices, wireless customer-premises equipment (CPE), or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts, and other information.

A mobile device is typically provided with at least one data processing entity 201, at least one memory 202 and other possible components 203 for use in software and hardware aided execution of tasks it is designed to perform, including control of access to and communications with access systems and other communication devices. The data processing, storage and other relevant components can be provided on an appropriate circuit board and/or in chipsets. This feature is denoted by reference 204. The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto.

The mobile device 200 may receive signals over an air or radio interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

FIG. 3 shows an example of a control apparatus 300 for a communication system, for example to be coupled to and/or for controlling a station of an access system, such as a RAN node, e.g. a base station, eNB or gNB, a relay node or a core network node such as an MME or Serving Gateway (S-GW) or Packet Data Network Gateway (P-GW), or a core network function such as AMF/SMF, or a server or host. The method may be implemented in a single control apparatus or across more than one control apparatus. The control apparatus may be integrated with or external to a node or module of a core network or RAN. In some embodiments, base stations comprise a separate control apparatus unit or module. In other embodiments, the control apparatus can be another network element such as a radio network controller or a spectrum controller. In some embodiments, each base station may have such a control apparatus as well as a control apparatus being provided in a radio network controller. The control apparatus 300 can be arranged to provide control on communications in the service area of the system. The control apparatus 300 comprises at least one memory 301, at least one data processing unit 302, 303 and an input/output interface 304. Via the interface the control apparatus can be coupled to a receiver and a transmitter of the base station. The receiver and/or the transmitter may be implemented as a radio front end or a remote radio head.

With the increasing popularity of AI/ML applications and the growing concern for sustainability, the following considers two contextual perspectives of AI/ML management in mobile networks, i.e., AI/ML model and sustainability.

A scheme of AI/ML model split has been introduced to reduce the energy consumption on the UE side. For example, an AI/ML model is split into two parts, one part to be deployed on a UE and the other part in the Operator Network (ON). The split is done in a way so that the workload of AI/ML inference can be offloaded from UE to ON. This may lead to a reduction of energy consumption on the UE side.

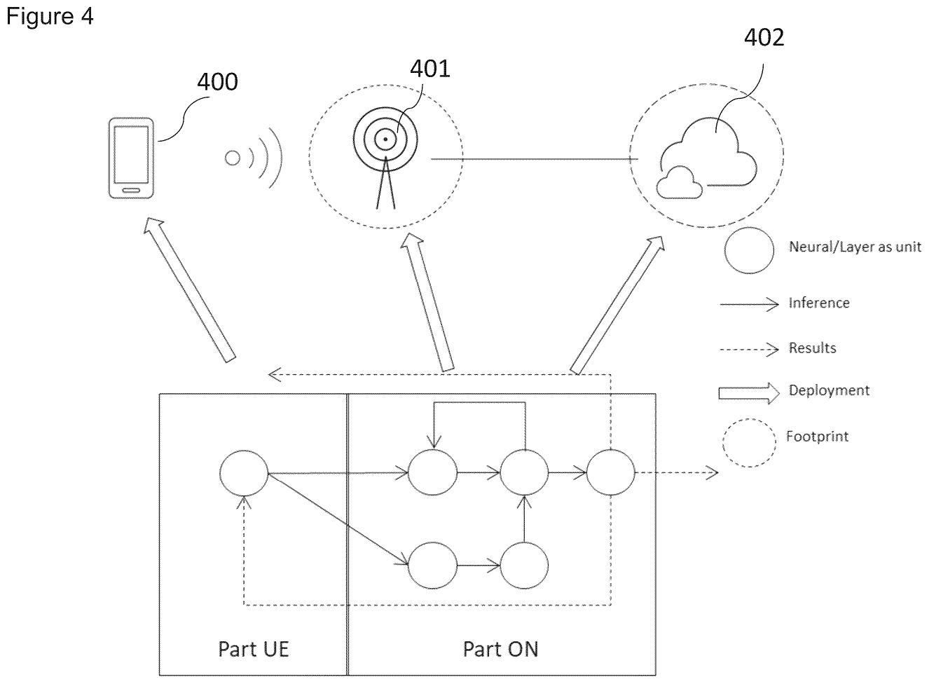

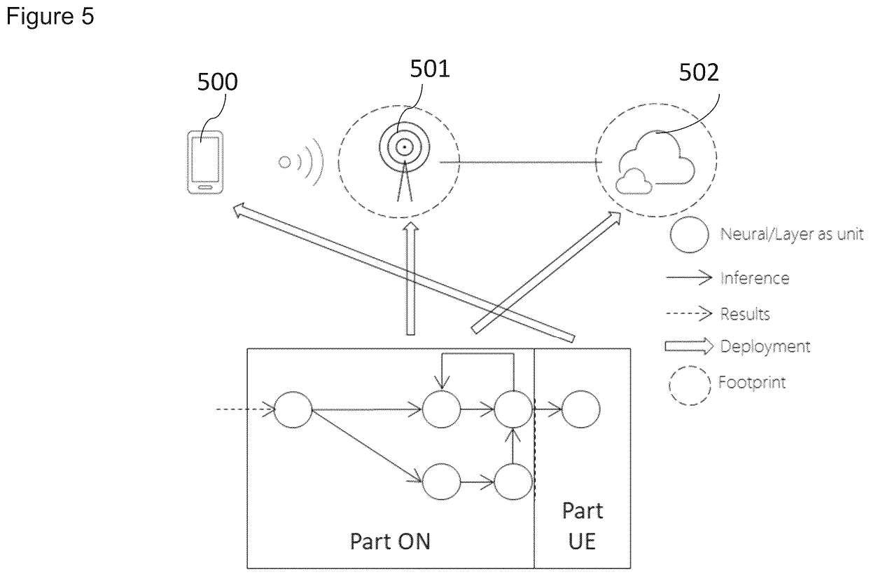

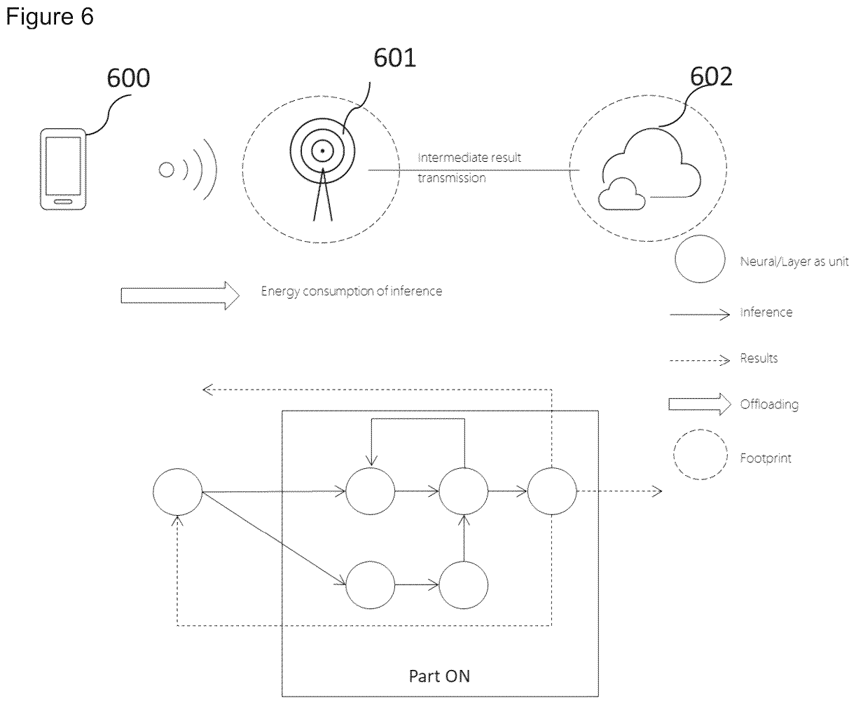

Two further scenarios of AI/ML model split for media services are illustrated by FIG. 4 and FIG. 5, respectively. In the scenarios shown in FIG. 4 and FIG. 5, a given AI/ML model is split into two parts. Part UE is to be deployed on UE and Part ON is to be deployed in the ON.

In scenario 1, illustrated in FIG. 4, the UE 400 performs inferences up to Part UE, and then sends the intermediate data to the network for the inference of Part ON. After Part ON's inference in the network (either at an edge server 401 or cloud server 402), the result is fed to the receiver. The receiver may be the origin UE 400, another UE in the same/different RAN, or a receiver in the DN. The carbon emission footprint of each server is indicated by the dashed circle.

In scenario 2, illustrated in FIG. 5, the UE 500 sends input data for the AI/ML model to the network for the inference up to Part ON (either at an edge server 501 or cloud server 502), and then intermediate data is sent back to the UE for Part UE inference. After Part UE's inference on the UE, the result is available on the UE. The carbon emission footprint of each server is indicated by the dashed circle.

The sustainability characteristics of network nodes may differ due to different energy consumption levels as well as the energy source. The carbon emission footprint of a network node is one characteristic which may be used to measure the environmental impact of the node. In the context of the AI/ML inference. A carbon emission footprint indicates the amount of produced CO2 emissions generated by a network node to perform an AI/ML inference task.

Let's consider carbon emission as an indicator of the environmental impact. The carbon emission of the network nodes varies depending on the type of energy, the time of energy consumption, the geographic location, etc. of the network nodes. Therefore, it may not always be optimal for a single network node to perform all the inference tasks that are offloaded into the network. In addition, data privacy, service latency, and other QoS requirements must also be taken into consideration. Hence, the host nodes need to be carefully selected. Finally, due to the offloading of the inference task, intermediate results of inference may need to be transmitted, which costs additional energy and latency. Thus, the parts of model to be deployed on the selected host nodes should be carefully derived.

In the face of increasing climate change, carbon emission footprint is becoming increasingly important as a measure of environmental impact. For network operators, the overall footprint of the ON should be optimized, considering that more and more AI/ML inference tasks will be offloaded into the ON. Therefore, the orchestration of environmental-aware model inference in the network to minimize the overall footprint of the network may be needed.

By leveraging the AI/ML model split, the AI/ML model inference task can be partially offloaded from UE to network nodes. In such a case, the environmental impact (e.g., carbon emission footprint) may be optimized on the UE side. However, task offload to the network would consume resources/energy and thus increase the network environmental impact (e.g., increase carbon emission), as shown in FIG. 6, where the energy consumption of the inference is offloaded from UE 600 to edge server 601 and cloud server 602. Therefore, the question of how to optimize the environmental impact/footprint of the AI inference of the network part is exposed.

Facing the challenge that huge amount of data generation and large deep learning model inference are not co-existing on a single network node, a method referred to as “Auto-Split” for end-to-end cloud-edge collaborative intelligence deployment of deep learning models has been proposed, to optimize the overall latency, by considering deep learning model structure and edge/cloud device constraints. This method focuses on optimizing latency instead of sustainability. With the proposed “Auto-Split”, the offloaded model is split to two units for deep learning model inference, i.e., for edge and cloud. The cost of transmitting the feature map output (i.e., intermediate data) from the first device (i.e., edge) to the second device (i.e., cloud) is not considered, which may impact the carbon emission footprint of the system.

A proposal to save energy on the network side for XR application and other similar demanding applications involves selecting devices hosting AI/ML models by considering energy efficiency, and model split for given host devices on the network side is an optional feature. In this proposal, the number of split AI/ML model is limited to the number of selected host devices. This proposal aims to optimizes energy consumption and not environmental impact (e.g., carbon emission footprint). Given these two differences, more carbon emission information and available host resources information may be expected.

Three model split principles have been proposed to reduce the workload of host devices in the network for AI/ML model inference and to guarantee service time, by considering both model structure, computing capacity of host devices, and the intermediate data transmission. However, the environmental impact is not part of the consideration of these proposals.

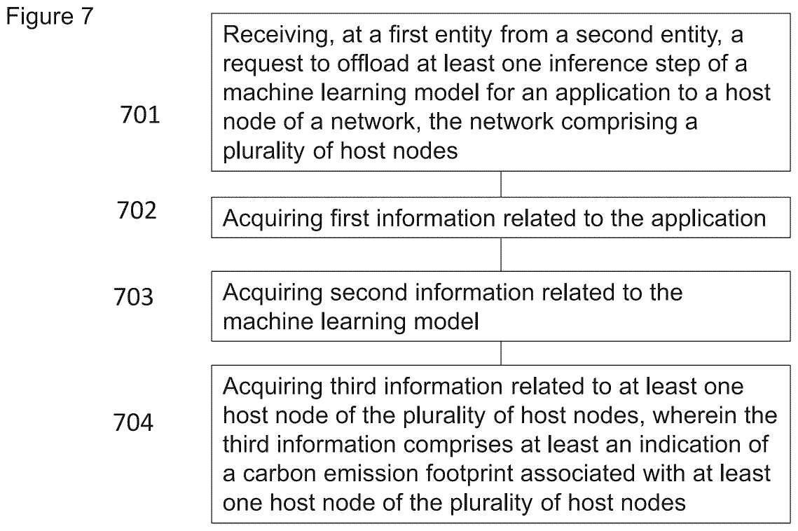

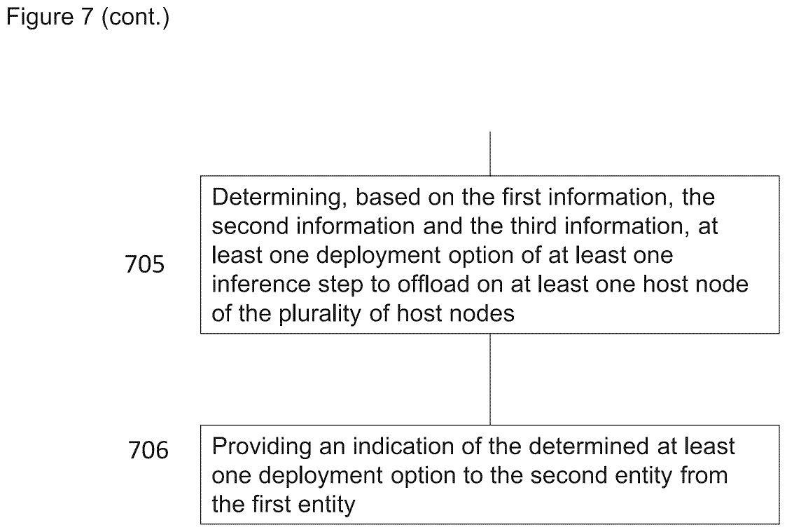

FIG. 7 shows a flowchart of a method according to an example embodiment. The method may be performed at a network function, e.g., at a MnS producer hosted on a network function.

In 701, the method comprises receiving, at a first entity from a second entity, a request to offload at least one inference step of a machine learning model for an application to a host node of a network, the network comprising a plurality of host nodes.

In 702, the method comprises acquiring first information related to the application.

In 703, the method comprises acquiring second information related to the machine learning model.

In 704, the method comprises acquiring third information related to at least one host node of the plurality of host nodes wherein the third information comprises at least an indication of a carbon emission footprint associated with at least one host node of the plurality of host nodes.

In 705, the method comprises determining, based on the first information, the second information and the third information, at least one deployment option of at least one inference step to offload on at least one host node of the plurality of host nodes.

In 706, the method comprises providing an indication of the determined at least one deployment option to the second entity.

Acquiring the first information may comprise receiving the first information at the first entity from the second entity.

Acquiring the second information may comprise requesting second information from a network function and receiving the second information from the network function.

Acquiring the third information may comprise requesting the third information from a further network function and receiving the third information from the further network function.

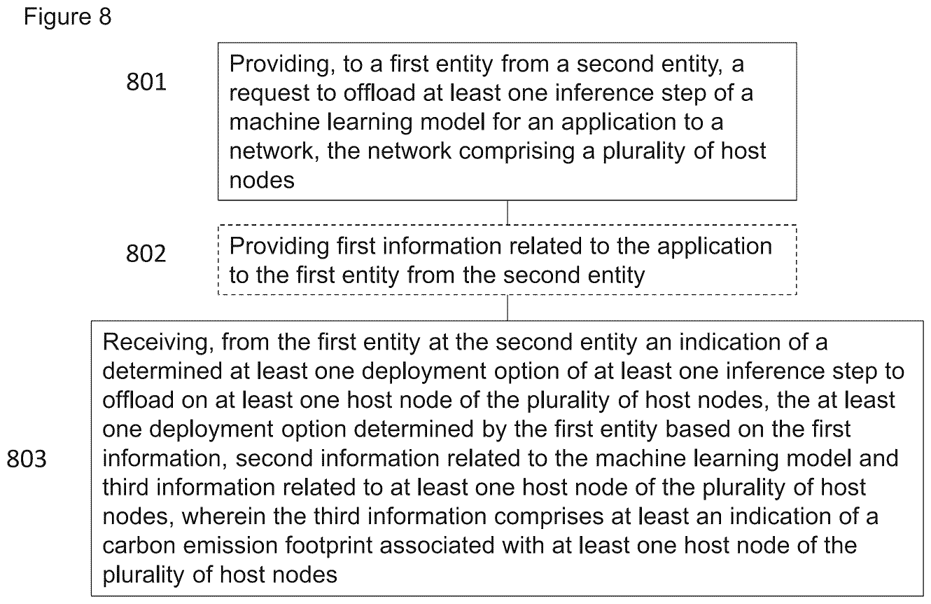

FIG. 8 shows a flowchart of a method according to an example embodiment. The method may be performed at a UE, a MnS consumer hosted on a network function or a machine learning entity or application.

In 801, the method comprises providing, to a first entity from a second entity, a request to offload at least one inference step of a machine learning model for an application to a host node of a network, the network comprising a plurality of host nodes.

Optionally, in 802, the method comprises providing first information related to the application to the first entity from the second entity.

In 803, the method comprises receiving, from the first entity at the second entity an indication of a determined at least one deployment option of at least one inference step to offload on at least one host node of the plurality of host nodes, the at least one deployment option determined by the first entity based on the first information, second information related to the machine learning model and third information related to at least one host node of the plurality of host nodes, wherein the third information comprises at least an indication of a carbon emission footprint associated with at least one host node of the plurality of host nodes.

The first entity may comprise a management service producer hosted on a network function. The second entity may comprise at least one of a user equipment, a management services consumer hosted on a network function or a machine learning entity. The plurality of host nodes may comprise at least one of edge cloud servers, centre cloud servers and network function servers.

An inference step may be referred to as a model unit. A model unit is a step of inference in the machine learning model, consisting of one or more neural/layer. A model unit is the minimum unit to be distributed. The inference of the UE part and all model units in the network compose the inference of the whole AI/ML model. A model unit may be identified by a ModelUnitID.

The minimum number of available host nodes is one, the maximum is, theoretically, the total number of network nodes. The available host nodes may be edge clouds, center cloud, available NF processing resources from underutilized NFs (in-network computing concept). Each host node may be identified by a NodeID.

The minimum number of the selected host nodes is one, the maximum number is the total number of module unit or network nodes.

The parameters of the model unit, minimum & maximum number of available and selected host nodes may be configured by MnS Producer at the beginning of the orchestration or derived from the information received related to AI/ML Model and Host Nodes. These parameters are the bounds of the deployment options that will be derived. The configuration of these parameters is optional.

The at least one deployment options may be determined such that the carbon emission footprint of the inference of the AI/ML model is minimised. The carbon emission footprint may be minimised subject to other requirements of the AI/ML model. The method may provide a function to orchestrate the host node selection and AI/ML model split of inferring AI/ML model in the network, to achieve an overall optimal carbon emission footprint, with respect to the given QoS of AI/ML applications. With the proposed method, the offloaded AI/ML inference task is split into several units, which are deployed on several selected distributed host nodes in the network. These selected host nodes perform the inference task in federated way.

Three information types may be defined to be used as input information to the proposed orchestration function, to obtain one or several deployment option(s) using the proposed method. It could be the case that more than one deployment options are obtained by the orchestration method with the given information.

The first information may comprise a quality of service (QOS) indicator. The QoS indicator may be mandatory. The first information may further comprise at least one of time sensitivity information, hardware requirements of at least one inference step and data privacy requirements of at least one inference step. The first information may be referred to as application-related information.

The first information, e.g., application-related information may be provided, e.g., by a UE, MnS Consumer, or ML Entity/ML App. The quality of service indicator may be a QoS characteristic (e.g., latency, bit rate). The first information may include requirements regarding host node selection and AI/ML model split, such as privacy of data processing (this is an example of data privacy requirements of an inference step), dedicated hardware (this is an example of hardware requirements of an inference step), and time sensitivity.

The privacy of data processing may lead to an exclusion of a host node under a certain acceptable level. The requirement of dedicated hardware may force a certain AI/ML model unit to be deployed on a chosen host node. The QoS of the AI/ML model inference should be guaranteed.

The first information may comprise an indication of at least one inference step of the machine learning model to be offloaded to at least one of the plurality of host nodes.

For example, the second entity (e.g., UE or MnS consumer) may define the part of AI/ML inference task to be offloaded in the network, e.g., Part ON in FIGS. 4 and 5. This may guarantee non-sustainability requirements of the application.

Alternatively, the second entity may not define what part of the AI/ML model is to be offloaded in the network and the network will by default offload the whole AI/ML model.

The request may comprise the first information.

The second information may at least one of input data size, output data size, computing complexity and parameter size of at least one inference step of the machine learning model. The second information, e.g., AI/ML-related information, may be provided by a network function, e.g., NWDAF, ADRF, or AIML Training Function/Model Producer. The second information may indicate the structure of the ML model without exposing proprietary details and computing complexity of the AI/ML model to be offloaded. With this information, the computing dependency and the size of intermediate results (size of intermediate results may be an example of input or output data size of an inference step) can be obtained, which may play a role in model splitting (i.e., determining deployment options). For example, a split point with a big size of intermediate results may be avoided.

The third information may further comprise computing capacity (e.g., the CPU/GPU capacity, storage capacity) of at least one of the host nodes. The third information may be referred to as host node-related information. The third information is provided by a further network function, e.g., service exposure function.

The host node related information may show how much computing capacity (e.g., computing power, storage) can be provided by each available host node. It may also describe with “carbon emission footprint index” how much carbon will be produced by consuming a unit of energy on each available host node. The carbon emission footprint index is an example of an indication of a carbon emission footprint associated with at least one host node. The carbon emission footprint may be used as an environmental impact indicator of each available host node. With this information, it can be ensured that the selected host node can provide sufficient computing capacity with the reduced carbon emission footprint.

The information “carbon emission footprint index” may be shared as a new attribute to NRF by available network nodes via existing interfaces. The “carbon emission footprint index” varies depending on the region, the energy source, and time. The value can be collected by the network operators from their energy providers or be generated based on governments and public organizations published index such as for example, the European Environment Agency of EU, the United States Environmental Protection Agency, or other third organizations.

Three information types are used as input, e.g., application-related information, AI/ML-related information, and host node-related information. Attributes of the three information types are defined in Table 1.

TABLE 1

| Type | Information Name | Description | Category |
|---|---|---|---|
| Application- | QOS | QOS characteristics defined in TS | Mandatory |
| related | | 23.501 V18.1.0 Clause 5.7.3, e.g., | |
| information | | packet delay budget, packet error rate. | |
| | Offload AI/ML model | Indicates if the consumer requires | Optional |
| | Attributes: | offloading of AIML inference into the | |
| | Offload AI/ML Model - | network. May contain a list of AIML | |
| | [Y/N Boolean] | model units to be offloaded into the | |
| | Required Offloaded | network. If this information is not given, | |
| | part - List{ | the MnS Producer will orchestrate the | |
| | ModelSplitID - [String] | workload of the entire AI/ML model. | |
| | Privacy of data | A list of model units with expected | Optional |
| | processing | privacy level, to indicate that the | |
| | Attributes: | inference of a model unit can only be | |
| | List{ | performed on a host device fulfilling a | |
| | ModelSplitID [String], | certain privacy level. Without giving the | |
| | PrivacyReq[String] | list, it's by default that all host devices | |
| | } | fulfill the privacy level. | |
| | Required dedicated | A list of model units with required | Optional |
| | hardware | dedicated hardware, to indicate that | |
| | Attributes: | the inference of a model unit requires a | |
| | List{ | certain dedicated hardware. Without | |
| | ModelSplitID [String], | giving the list, it's by default that no | |
| | HWReq[String] | dedicated hardware is needed by any | |
| | } | model unit. | |
| AI/ML- | Whole AI/ML model | This information describes the | Conditional, |
| related | structure | structure of the whole AI/ML model, | only when |
| information | Attributes: | that can be offloaded into the network, | the |
| | ModelID - [String] | including the dependency, the input | information |
| | ModelSplitNum - [Int] | and output data size, computing | “offload |
| | List{ | complexity, and the size of parameters | AI/ML |
| | ModelSplitID - [String], | of each model unit. | model” is |
| | dependency - [String], | | not given by |
| | In/OutDataSize - | | UE. |
| | [Float], | | |
| | ParSize - [Float], | | |
| | FLOPs - [Float]} | | |
| | } | | |
| | Partial AI/ML model | This information describes the | Conditional, |
| | structure | structure of the AI/ML model to be | only when |
| | Attributes: | offloaded into the network defined by | the |
| | ModelID - [String] | UE including the dependency, the input | information |
| | List{ | and output data size, computing | “offload |
| | ModelSplitID - [String], | complexity, and the size of parameters | AI/ML |
| | dependency - [String], | of each model unit listed in the “offload | model” is |
| | In/OutDataSize - | AI/ML model”. | given by |
| | [Float], | | UE. |
| | ParSize - [Float], | | |
| | FLOPs - [Float]} | | |
| Host node- | Computing resource | This information describes the | Mandatory |
| related | Attributes: | computing resource that a host node | |
| information | List{ | can provide, including the CPU/GPU | |
| | NodelID - [String] | capacity, storage capacity, and other | |
| | CPU - [String], | information relating AI/ML model | |
| | GPU - [String] | inference. | |
| | Storage - [Float]} | | |
| | Carbon emission | This information shows the amount of | Mandatory |
| | footprint index | carbon emission (e.g., g CO2e) | |
| | Attributes: | produced by consuming a unit (e.g., | |
| | List{ | kWh) of energy by a host node, i.e, to | |
| | NodelID - [String] | perform a given inference workload or | |
| | Carbon emission per | to transmit a given amount of the data. | |
| | kWh - [Float]} | | |

Based on the privacy of data processing and dedicated hardware, some available network nodes may be excluded for offloading. Model units with high workload may prefer to be deployed on the network nodes with a low carbon emission footprint index. Limited by the computing dependency of some model units, the model units may be deployed on different network nodes. Limited by the intermediate results, some model units may be co-located on same network nodes.

In an example embodiment, a call flow may have the following steps.

The UE, any MnS Consumer (e.g., AF, NF), or ML Entity/ML App initiates the request of the distributed offloading of models into the network, with the given application requirements. The UE or MnS Consumer may choose to specify a certain portion of the inference task to be offloaded to the network, or leave no portion specified and have the whole inference task offloaded to the network. This is an example of providing, to a first entity from a second entity, a request to offload at least one inference step of a machine learning model for an application to a network, the network comprising a plurality of host nodes.

The MnS Producer hosted in MDAF, AF or an equivalent network management function will derive, which AI/ML model unit should be deployed on which host node, after collecting the AI/ML-and host node-related information from NWDAF or ADRF or AI/ML Training Function/Model Producer, and or a service exposure function (e.g., NRF). This is an example of determining, based on first information, second information and third information, at least one deployment option of at least one inference step to offload on at least one host node of the plurality of host nodes, wherein the third information comprises at least an indication of a carbon emission footprint associated with at least one host node of the plurality of host nodes.

The obtained deployment option is sent to offloading function, i.e., MnS consumer or UE. This is an example of providing an indication of the determined at least one deployment option to the second entity from the first entity. The model units to be offloaded are then deployed on several host nodes in a federated manner. The intermediate results are shared among host nodes if required. The intermediate result is transmitted among the host devices if it is needed for inference.

In the case of more than one deployment options obtained, the MnS consumer or UE selects one option to be deployed. This is an example of the second entity receiving an indication of a plurality of deployment options and determining to use one of the deployment options to offload at least one inference step to at least one host node. The selection may be random, based on criteria set by a UE (e.g., but not limited to, the least number of inference steps that will be offloaded on the UE or the least amount of data forwarded by the UE) or any other suitable method for determining which of a plurality of deployment options to use.

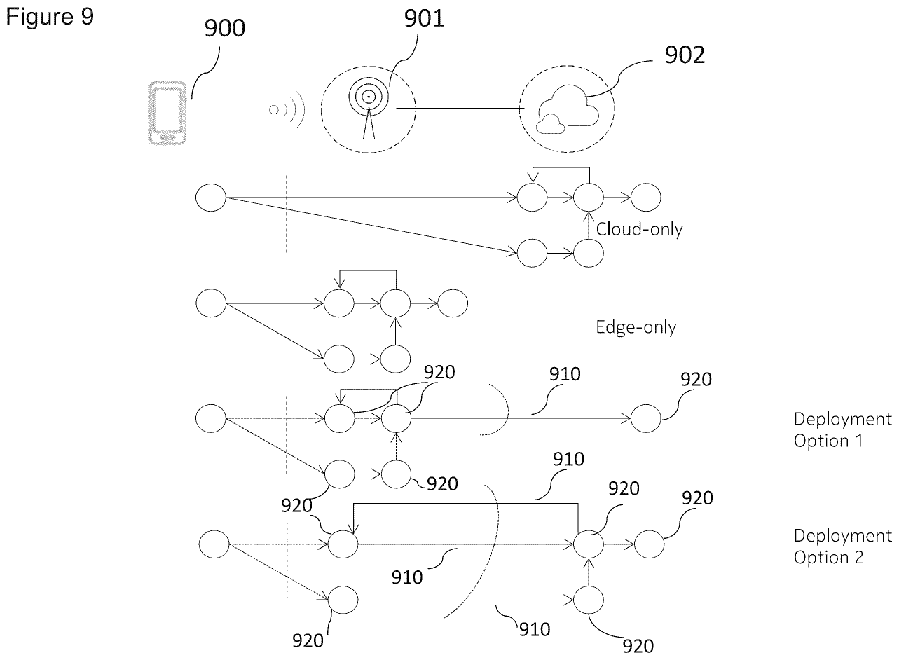

FIG. 9 shows an illustration of two different example deployment (or “federated inference orchestration”) options deployment option 1 and deployment option 2, of model units 920 from a UE 900 to host nodes 901 and 902, by considering the footprint of intermediate data transmission 910, the footprint and computing complexity of AL/ML model units 920, as well as the computing dependency of these units (arrowed lines between the UE and model units 920).

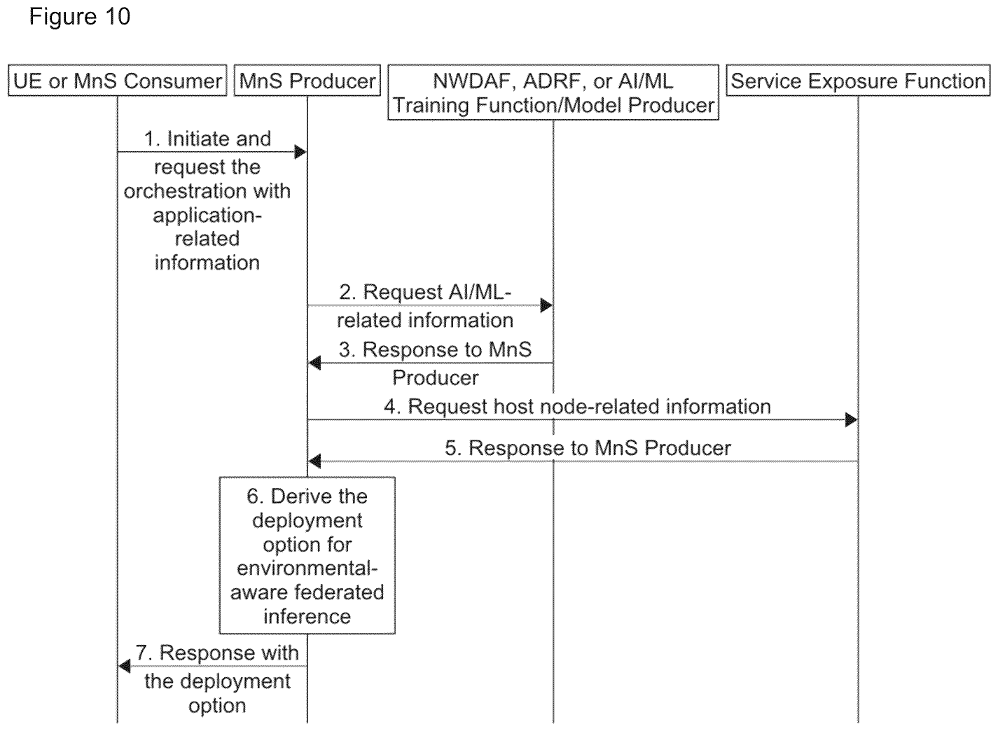

FIG. 10 shows an example of a call flow and signaling in an example embodiment where the second entity is a UE or MnS Consumer.

Step 1 comprises initiating the orchestration request by UE or MnS Consumer. UE or MnS Consumer indicates the requirements of the orchestration defined in the application-related information in Table 1. The requirements include the QoS that the inference must fulfill. This is an example of receiving, at a first entity from a second entity, a request to offload at least one inference step of a machine learning model for an application to a host node of a network, the network comprising a plurality of host nodes and receiving first information related to the application from the first entity.

The requirements may include the model units of an AI/ML model to be offloaded into the network, if the UE defines the IE “offload AI/ML model”. Otherwise, the entire AI/ML model will be seen as the task to be offloaded during the orchestration. The requirements of UE may include the privacy and hardware requirements. In this example, the first information comprises a QoS indicator and may include privacy requirements of at least one inference step hardware requirements of at least one inference step and an indication of at least one inference step of the machine learning model to be offloaded to at least one of the plurality of host nodes.

There are two example options to realize the initiation

In option A, the UE or MnS Consumer initiates and requests the orchestration to MnS Producer directed, by sharing the application-related information defined in Table 1.

Option B comprises two steps.

In step 1a of option B, the UE initiates the orchestration to a MnS Consumer, by sharing the application-related information defined in Table 1.

In step 1b of option B, the MnS Consumer requests the orchestration service to MnS Producer, by forwarding the application-related information from UE.

The difference between option A and option B is which entity is going to enforce the derived deployment option after the orchestration. In the case of option A, the UE will receive the derived deployment options and choose one deployment option to start the enforcement. In the case of option B, the MnS Consumer entity will receive the derived deployment options and perform the enforcement and UE will get a response only from the MnS Consumer. These procedures are described with reference to Step 7 Option A and Option B, respectively.

In step 2, the MnS Producer takes action to collect information about the computing and transmission resource required by AI/ML model units indicated by UE if the IE “offload AI/ML model” is given by UE. Otherwise, MnS Producer takes action to collect information about the computing and transmission resource required by all model units of the entire AI/ML model. MnS Producer requests the AI/ML-related information defined in Table 1 from NWDAF, ADRF, or AIML Training Function/Model Producer.

In step 3, the NWDAF, ADRF, or AIML Training Function/Model Producer provides the requested AI/ML-related information, and responses to MnS Producer. Steps 2 and 3 are an example of requesting second information from a network function and receiving the second information from the network function.

In step 4, the MnS Producer takes action to collect information about the computing and transmission resource, that can be provided by all available network nodes. The MnS Producer requests the host node-related information defined in Table 1 from a service exposure function.

In step 5, the Service exposure function provides the requested host node-related information, and responses to MnS Producer. Steps 4 and 5 are an example of requesting the third information from a further network function and receiving the third information from the further network function.

In step 6, after collecting all related information, MnS Producer derives the deployment options for environmental-aware federated inference. Several network nodes are selected as host node, and the model units deployed on these host nodes are determined. The host node selection and model unit deployment compose the final deployment option. The deployment option could be in the form of a tuple as follows: OptionID—[String], list {NodeID—[String], ModelUnitID—[String]}. This is an example of determining, based on the first information, the second information and the third information, at least one deployment option of at least one inference step to offload on at least one host node of the plurality of host nodes.

In step 7, after the MnS Producer has derived the final deployment option(s), the final deployment option(s) is/are provided in response to the UE. There are two options to respond to the UE, corresponding to the two options of step 1. This step is an example of providing an indication of the determined at least one deployment option to the second entity from the first entity.

In option A, the MnS Producer responds to UE or MnS Consumer with the deployment option.

Option B involves two steps. In step 7a, the MnS Producer responds to the MnS Consumer with the deployment option. In step 7b, the MnS Consumer responds the completion of the request to UE.

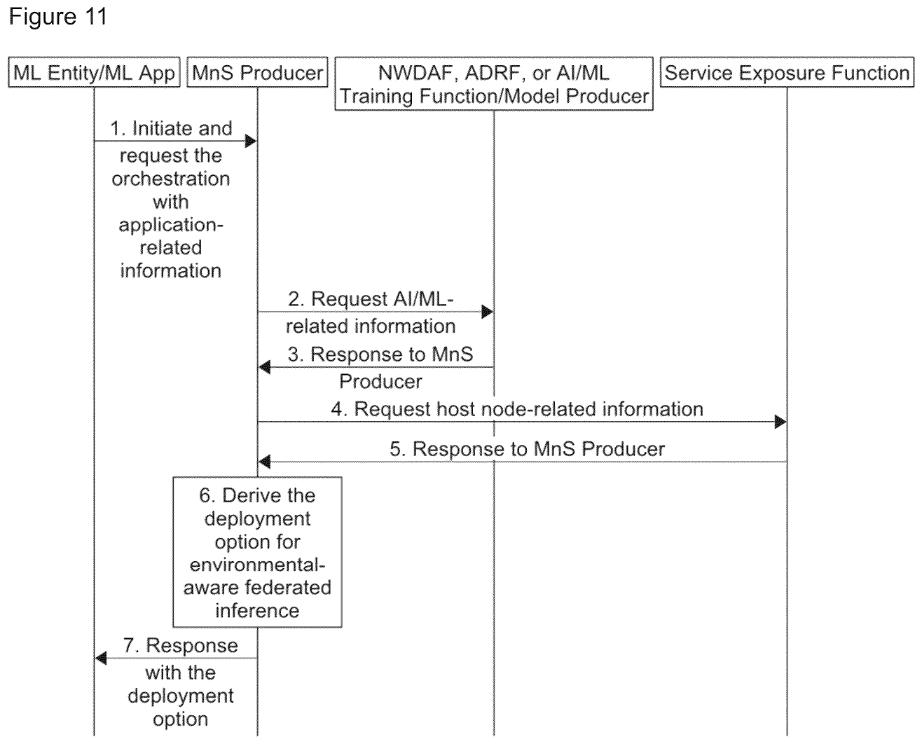

FIG. 11 shows a call flow and signaling according to an example embodiment where the second entity is a AI/ML entity (“ML entity”) or AI/ML application (“ML app”).

Step 1 comprises initiating the orchestration request by ML Entity/ML App. ML Entity/ML App indicates requirements of the orchestration defined in the application-related information in Table 1. This is an example of receiving, at a first entity from a second entity, a request to offload at least one inference step of a machine learning model for an application to a host node of a network, the network comprising a plurality of host nodes and receiving first information related to the application from the first entity.

The requirements include the QoS that the inference must fulfill. The requirements may include the model units of an AI/ML model to be offloaded into the network, if the ML Entity/ML App defines the IE “offload AI/ML model”. Otherwise, the entire AI/ML model will be seen as the task to be offloaded during the orchestration. The requirement of ML Entity/ML App may include privacy and hardware. ML Entity/ML App requests the orchestration service to MnS Producer. In this example, the first information comprises a QoS indicator and may include privacy requirements of at least one inference step hardware requirements of at least one inference step and an indication of at least one inference step of the machine learning model to be offloaded to at least one of the plurality of host nodes.

In step 2, the MnS Producer takes action to collect information about the computing and transmission resource required by AI/ML model units indicated by ML Entity/ML App if the IE “offload AI/ML model” is given by ML Entity/ML App. Otherwise, MnS Producer takes action to collect information about the computing and transmission resource required by all model units of the entire AI/ML model. MnS Producer requests the AI/ML-related information defined in Table 1 from NWDAF, ADRF, or AIML Training Function/Model Producer.

In step 3, the NWDAF, ADRF, or AIML Training Function/Model Producer provides the requested AI/ML-related information, and responses to MnS Producer.

Steps 2 and 3 are an example of requesting second information from a network function and receiving the second information from the network function.

In step 4, the MnS Producer takes action to collect information about the computing and transmission resource, that can be provided by all available network nodes. MnS Producer requests the host node-related information defined in Table 1 from a service exposure function.

In step 5, the service exposure function provides the requested host node-related information, and responses to MnS Producer.

Steps 4 and 5 are an example of requesting the third information from a further network function and receiving the third information from the further network function.

In step 6, after collecting all related information, MnS Producer derives the deployment options for environmental-aware federated inference. Several network nodes are selected as host nodes, and the model units deployed on these host nodes are determined. The host node selection and model unit deployment compose the final deployment option. The deployment option could be in the form of a tuple as follows: OptionID—[String], list {NodeID—[String], ModelUnitID—[String]}. This is an example of determining, based on the first information, the second information and the third information, at least one deployment option of at least one inference step to offload on at least one host node of the plurality of host nodes.

In step 7, after the MnS Producer derived the deployment option(s), the final deployment option(s) is/are provided to ML Entity/ML App. ML Entity/ML App will receive the derived deployment options and choose one deployment option to start the enforcement. This step is an example of providing an indication of the determined at least one deployment option to the second entity from the first entity.

An apparatus may comprise means for receiving, at a first entity from a second entity, a request to offload at least one inference step of a machine learning model for an application to a host node of a network, the network comprising a plurality of host nodes, means for acquiring first information related to the application, means for acquiring second information related to the machine learning model, means for acquiring third information related to at least one host node of the plurality of host nodes, wherein the third information comprises at least an indication of a carbon emission footprint associated with at least one host node of the plurality of host nodes, means for determining, based on the first information, the second information and the third information, at least one deployment option of at least one inference step to offload on at least one host node of the plurality of host nodes and means for providing an indication of the determined at least one deployment option to the second entity from the first entity.

The apparatus may comprise a network function, be the network function or be comprised in the network function or a chipset for performing at least some actions of/for the network function.

An apparatus may comprise means for providing, to a first entity from a second entity, a request to offload at least one inference step of a machine learning model for an application to a network, the network comprising a plurality of host nodes and means for receiving, from the first entity at the second entity an indication of a determined at least one deployment option of at least one inference step to offload on at least one host node of the plurality of host nodes, the at least one deployment option determined by the first entity based on first information related to the application, second information related to the machine learning model and third information related to at least one host node of the plurality of host nodes, wherein the third information comprises at least an indication of a carbon emission footprint associated with at least one host node of the plurality of host nodes.

The apparatus may comprise a user equipment, such as a mobile phone, be the user equipment or be comprised in the user equipment or a chipset for performing at least some actions of/for the user equipment.

Alternatively, or in addition, the apparatus may comprise a network function, be the network function or be comprised in the network function or a chipset for performing at least some actions of/for the network function.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst some embodiments have been described in relation to 5G networks, similar principles can be applied in relation to other networks and communication systems such as 6G networks or 5G-Advanced networks. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

In general, the various embodiments may be implemented in hardware or special purpose circuitry, software, logic or any combination thereof. Some aspects of the disclosure may be implemented in hardware, while other aspects may be implemented in firmware or software which may be executed by a controller, microprocessor or other computing device, although the disclosure is not limited thereto. While various aspects of the disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
I hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The embodiments of this disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media. The term “non-transitory,” as used herein, is a limitation of the medium itself (i.e., tangible, not a signal) as opposed to a limitation on data storage persistency (e.g., RAM vs. ROM).

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The scope of protection sought for various embodiments of the disclosure is set out by the independent claims. The embodiments and features, if any, described in this specification that do not fall under the scope of the independent claims are to be interpreted as examples useful for understanding various embodiments of the disclosure.

The foregoing description has provided by way of non-limiting examples a full and informative description of the exemplary embodiment of this disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of this invention as defined in the appended claims. Indeed, there is a further embodiment comprising a combination of one or more embodiments with any of the other embodiments previously discussed.

1. An apparatus comprising:
at least one processor, and at least one memory including computer program code,
wherein the at least one memory and the computer program code are configured, with the at least one processor, to cause the apparatus at least to perform:
receiving, at a first entity from a second entity, a request to offload at least one inference step of a machine learning model for an application to a host node of a network, the network comprising a plurality of host nodes;
acquiring first information related to the application;
acquiring second information related to the machine learning model;
acquiring third information related to at least one host node of the plurality of host nodes, wherein the third information comprises at least an indication of a carbon emission footprint associated with at least one host node of the plurality of host nodes;
determining, based on the first information, the second information and the third information, at least one deployment option of at least one inference step to offload on at least one host node of the plurality of host nodes; and
providing an indication of the determined at least one deployment option to the second entity from the first entity.

2. The apparatus according to claim 1, wherein the acquiring the first information comprises receiving the first information at the first entity from the second entity.

3. The apparatus according to claim 1, wherein the acquiring the second information comprises requesting the second information from a network function and receiving the second information from the network function.

4. The apparatus according to claim 1, wherein the acquiring the third information comprises requesting the third information from a further network function, and receiving the third information from the further network function.

5. The apparatus according to claim 1, wherein the first information comprises an indication of at least one inference step of the machine learning model to be offloaded to at least one of the plurality of host nodes.

6. The apparatus according to claim 1, wherein the first information comprises a quality of service indicator.

7. The apparatus according to claim 6, wherein the first information comprises at least one of time sensitivity information, hardware requirements of at least one inference step and data privacy requirements of at least one inference step

8. The apparatus according to claim 1, wherein the request comprises the first information.

9. The apparatus according to claim 1, wherein the third information further comprises an indication of computing capacity of at least one host node of the plurality of host nodes.

10. The apparatus according to claim 1, wherein the second information comprises at least one of input data size, output data size, computing complexity and parameter size of at least one inference step of the machine learning model.

11. The apparatus according to claim 1, wherein the first entity comprises a management service producer hosted on a network function.

12. The apparatus according to claim 1, wherein the second entity comprises at least one of a user equipment, a management services consumer hosted on a network function or a machine learning entity.

13. The apparatus according to claim 1, wherein the plurality of host nodes comprise at least one of edge cloud servers, centre cloud servers and network function servers.

14. An apparatus comprising:
at least one processor, and at least one memory including computer program code,
wherein the at least one memory and the computer program code are configured, with the at least one processor, to cause the apparatus at least to perform:
providing, to a first entity from a second entity, a request to offload at least one inference step of a machine learning model for an application to a network, the network comprising a plurality of host nodes; and
receiving, from the first entity at the second entity an indication of a determined at least one deployment option of at least one inference step to offload on at least one host node of the plurality of host nodes, the at least one deployment option determined by the first entity based on first information related to the application, second information related to the machine learning model and third information related to at least one host node of the plurality of host nodes, wherein the third information comprises at least an indication of a carbon emission footprint associated with at least one host node of the plurality of host nodes.

15. The apparatus according to claim 14, wherein the at least one memory and the computer program code are configured, with the at least one processor, to cause the apparatus to perform: providing the first information to the first entity from the second entity.

16. The apparatus according to claim 14, wherein the first information comprises an indication of at least one inference step of the machine learning model to be offloaded to at least one of the plurality of host nodes.

17. The apparatus according to claim 14, wherein the first information comprises a quality of service indicator.

18. The apparatus according to claim 17, wherein the first information comprises at least one of time sensitivity information, hardware requirements of at least one inference step and data privacy requirements of at least one inference step

19. The apparatus according to claim 14, wherein the request comprises the first information.

20. The apparatus according to claim 14, wherein the third information further comprises an indication of computing capacity of at least one host node of the plurality of host nodes.
